(19) United States
(12) Patent Application Publication
(10) Pub. No.: US 2026/0304097 A1
(43) Pub. Date: Oct. 1, 2026

(54) METHOD AND SYSTEM FOR COLLECTING DATA FOR TRAINING AND MONITORING THE PERFORMANCE OF AN ARTIFICIAL INTELLIGENCE MODEL FOR LOCATION MEASUREMENT

(71) Applicant: ELECTRONICS AND TELECOMMUNICATIONS RESEARCH INSTITUTE, Daejeon (KR)

(72) Inventors: Chang Sik LEE, Daejeon (KR); Tae Yeon KIM, Daejeon (KR); Jeoung Lak HA, Daejeon (KR)

(73) Assignee: ELECTRONICS AND TELECOMMUNICATIONS RESEARCH INSTITUTE, Daejeon (KR)

(21) Appl. No.: 19/578,673

(22) Filed: Mar. 25, 2026

(30) Foreign Application Priority Data
Mar. 27, 2025 (KR) 10-2025-0039853
Apr. 15, 2025 (KR) 10-2025-0049160
Jun. 10, 2025 (KR) 10-2025-0075902
Sep. 1, 2025 (KR) 10-2025-0123118
Nov. 4, 2025 (KR) 10-2025-0164604
Mar. 19, 2026 (KR) 10-2026-0049340

(51) Int. Cl. H04W 8/18; H04W 4/02

(52) U.S. Cl. CPC H04W 8/18; H04W 4/02

(57) ABSTRACT

According to one embodiment of the present disclosure, a method performed by a Location Management Function (LMF) device may include receiving a subscription request for input data from a Network Data Analytics Function (NWDAF) device; checking whether a user equipment (UE) has user consent for a purpose of data collection through a Unified Data Management (UDM) device; and collecting data related to the UE based on checking that the user consent for the purpose of data collection has been authorized; and providing the data related to the UE to the NWDAF device.

### CROSS-REFERENCE TO RELATED APPLICATIONS

This application claims the benefit of earlier filing date and right of priority to Korean Application No. 10-2025-0039853, filed on Mar. 27, 2025, Korean Application No. 10-2025-0049160, filed on Apr. 15, 2025, Korean Application No. 10-2025-0075902, filed on Jun. 10, 2025, Korean Application No. 10-2025-0123118, filed on Sep. 1, 2025, Korean Application No. 10-2025-0164604, filed on Nov. 4, 2025, and Korean Application No. 10-2026-0049340, filed on Mar. 19, 2026, the contents of which are all hereby incorporated by reference herein in their entirety.

### TECHNICAL FIELD

The present disclosure relates to data collection technology, and more specifically, to a method and system for processing data for training and performance monitoring of an artificial intelligence (AI) model for location measurement based on LMF (Location Management Function).

### BACKGROUND

LMF is a location service function that collects and provides location information of a terminal. It can collect and calculate precise location information of the terminal and provide it to other external applications.

Also, NWDAF (Network Data Analytics Function) refers to a network function (NF) that performs AI/ML (machine learning)-based network analysis and prediction within a wireless communication system.

For example, NWDAF can provide a function that collects data from various NFs within a service-based architecture and analyzes and predicts the collected data to reflect it in subsequent policies.

Conventionally, when NWDAF requested input data from LMF, the purpose of the collected data was not specified, which resulted in a problem where the stable data collection procedure was not carried out efficiently.

### SUMMARY

The technical problem of the present disclosure is to a method and system for collecting data for training and performance monitoring of an artificial intelligence model for position measurement.

The technical problem of the present disclosure is to a method and system for NWDAF to subscribe to and collect input data from LMF.

The technical problems to be achieved in the present disclosure are not limited to the technical tasks mentioned above, and other technical problems not mentioned will be clearly understood by those skilled in the art from the description below.

According to one embodiment of the present disclosure, a method performed by a Location Management Function (LMF) device may include receiving a subscription request for input data from a Network Data Analytics Function (NWDAF) device; checking whether a user equipment (UE) has user consent for a purpose of data collection through a Unified Data Management (UDM) device; and collecting data related to the UE based on checking that the user consent for the purpose of data collection has been authorized; and providing the data related to the UE to the NWDAF device.

In addition, the purpose of the data collection may include at least one of an Artificial Intelligence (AI) model inference purpose, an AI model training purpose, and an AI model performance monitoring purpose.

In addition, the method may include transmitting, to the NWDAF device, an error response including a cause code indicating that data related to the UE cannot be provided to the NWDAF device, based on checking that the user consent for the purpose of the data collection has not been authorized.

In addition, the subscription request may include at least one of an Area of Interest (AoI), a Notification Target Address, a Notification Correlation ID, a requested number of data samples, a Time Window of data samples, a data source type, a quality threshold, a Subscription Correlation ID, an Expiry time, or an identifier of the AI model.

In addition, the providing data related to the UE to the NWDAF device may include based on a quality indicator of the Ground Truth data included in the data related to the UE being greater than or equal to the quality threshold, transmitting the data related to the UE to the NWDAF device.

In addition, the method may include storing the collected data in an Analytics Data Repository Function (ADRF) device.

In addition, the storing the collected data may include determining whether the ADRF device is authorized to store the data based on a privacy profile of the UE.

In addition, the providing data related to the terminal to the NWDAF device may include: transmitting the data related to the UE to the NWDAF device along with a data usage report indication.

In addition, the method may further include receiving a data usage result from the NWDAF device in response to the data usage report indication, the result including whether the data related to the UE was used for the purpose of data collection.

In addition, the method may include performing positioning of the UE through the AI model, and the performing positioning of the UE may include receiving a positioning request from a gateway mobile location center (GMLC) device to perform location positioning of the UE, and the positioning request may be transmitted from the GMLC device to the LMF device when a location positioning request for the UE is made from a different entity to the GMLC device, and the GMLC device verifies that the different entity has authority to access the location information of the UE.

According to one embodiment of the present disclosure, a Location Management Function (LMF) device may include at least one memory; and at least one processor, and the at least one processor is configured to: receive a subscription request for input data from a Network Data Analytics Function (NWDAF) device; check whether a user equipment (UE) has user consent for a purpose of data collection through a Unified Data Management (UDM) device; and collect data related to the UE based on checking that the user consent for the purpose of data collection has been authorized; and provide the data related to the UE to the NWDAF device.

In addition, the at least one processor may be configured to: transmit, to the NWDAF device, an error response including a cause code indicating that data related to the UE cannot be provided to the NWDAF device, based on checking that the user consent for the purpose of the data collection has not been authorized.

In addition, the at least one processor may be configured to: based on a quality indicator of the Ground Truth data included in the data related to the UE being greater than or equal to the quality threshold, transmit the data related to the UE to the NWDAF device.

In addition, the at least one processor may be configured to: store the collected data in an Analytics Data Repository Function (ADRF) device.

In addition, the at least one processor may be configured to: determine whether the ADRF device is authorized to store the data based on a privacy profile of the UE.

In addition, the at least one processor is configured to transmit data related to the terminal to the NWDAF device along with a data usage report indication.

In addition, the at least one processor is configured to: receive a data usage result from the NWDAF device, including a result of whether the data associated with the UE was used for the purpose of data collection, in response to the data usage report indication.

In addition, the at least one processor may be configured to: perform positioning of the UE through the AI model.

In addition, the at least one processor may be configured to receive a positioning request from a gateway mobile location center (GMLC) device to perform location positioning of the UE, and the positioning request may be transmitted from the GMLC device to the LMF device when a location positioning request for the UE is made from a different entity to the GMLC device, and the GMLC device verifies that the different entity has authority to access the location information of the UE.

According to one embodiment of the present disclosure, a system may include a Location Management Function (LMF) device; and a Network Data Analytics Function (NWDAF) device, and the LMF device may be configured to: receive a subscription request for input data from the NWDAF device; check whether a user equipment (UE) has user consent for a purpose of data collection through a Unified Data Management (UDM) device; and collect data related to the UE based on checking that the user consent for the purpose of data collection has been authorized, and the NWDAF device may be configured to: receive the data related to the UE from the LMF device.

According to one embodiment of the present disclosure, a method may include receiving a subscription request for input data from a Network Data Analytics Function (NWDAF) device by a Location Management Function (LMF) device; checking whether the UE has user consent for the purpose of data collection through a Unified Data Management (UDM) device by the LMF device; collecting data related to the UE by the LMF device based on the confirmation that the user consent for the purpose of data collection has been granted by the LMF device; receiving data related to the terminal from the LMF device by the NWDAF device; and storing the collected data in an Analytics Data Repository Function (ADRF) device by the LMF device

The features briefly summarized above with respect to the disclosure are merely exemplary aspects of the detailed description of the disclosure that follows, and do not limit the scope of the disclosure.

By various embodiments of the present disclosure, a method and system for collecting data for training and performance monitoring of an artificial intelligence model for location measurement may be provided.

By various embodiments of the present disclosure, a method and system for specifying the purpose of data collection when NWDAF subscribes to and collects input data from LMF may be provided.

The effects obtainable from the present disclosure are not limited to those mentioned above, and other unmentioned effects will be clearly understood by those skilled in the art to which the present disclosure belongs from the description below.

### BRIEF DESCRIPTION OF THE DRAWINGS

The accompanying drawings included as part of the detailed description to facilitate understanding of the present disclosure provide embodiments of the present disclosure and describe technical features of the present disclosure along with detailed descriptions.

FIG. 1 is a diagram illustrating the configuration of a network of a 5G mobile communication network.

FIG. 2 is a diagram illustrating a method for collecting data for training an LMF-based location measurement model or for performance monitoring according to an embodiment of the present disclosure.

FIG. 3 is a diagram illustrating a method for collecting input data of an NWDAF for training an AI model for location measurement and/or for performance monitoring according to an embodiment of the present disclosure.

FIG. 4A relates to an NWDAF service profile registration procedure according to an embodiment of the present disclosure.

FIG. 4B relates to an NWDAF discovery procedure according to an embodiment of the present disclosure.

FIG. 5 is a flowchart illustrating a method for collecting input data and estimating performance of an AI model for location estimation according to an embodiment of the present disclosure.

FIG. 6 is a diagram illustrating the configuration of a device according to an embodiment of the present disclosure.

### DETAILED DESCRIPTION

Since the present disclosure can make various changes and have various embodiments, specific embodiments are illustrated in the drawings and described in detail in the detailed description. However, this is not intended to limit the present disclosure to specific embodiments, and should be understood to include all modifications, equivalents, and substitutes included in the idea and scope of the present disclosure. Similar reference numbers in the drawings indicate the same or similar function throughout the various aspects. The shapes and sizes of elements in the drawings may be exaggerated for clarity. Detailed description of exemplary embodiments to be described later refers to the accompanying drawings, which illustrate specific embodiments by way of example. These embodiments are described in sufficient detail to enable those skilled in the art to practice the embodiments. It should be understood that the various embodiments are different, but need not be mutually exclusive. For example, specific shapes, structures, and characteristics described herein may be implemented in another embodiment without departing from the idea and scope of the present disclosure in connection with one embodiment. Additionally, it should be understood that the location or arrangement of individual components within each disclosed embodiment may be changed without departing from the spirit and scope of the embodiment. Accordingly, the detailed description set forth below is not to be taken in a limiting sense, and the scope of the exemplary embodiments, if properly described, is limited only by the appended claims, along with all equivalents as claimed by those claims.

In this disclosure, terms such as first and second may be used to describe various components, but the components should not be limited by the terms. These terms are only used for the purpose of distinguishing one component from another. For example, a first element may be termed a second element, and similarly, a second element may be termed a first element, without departing from the scope of the present disclosure. The term and/or includes a combination of a plurality of related recited items or any one of a plurality of related recited items.

When an element of the present disclosure is referred to as being “connected” or “connected” to another element, it may be directly connected or connected to the other element, but it should be understood that other components may exist in the middle. On the other hand, when an element is referred to as “directly connected” or “directly connected” to another element, it should be understood that no other element exists in the middle.

Components appearing in the embodiments of the present disclosure are shown independently to represent different characteristic functions, and do not mean that each component is composed of separate hardware or a single software component. That is, each component is listed and included as each component for convenience of description, and at least two components of each component are combined to form one component, or one component can be divided into a plurality of components to perform functions. An integrated embodiment and a separate embodiment of each of these components are also included in the scope of the present disclosure unless departing from the essence of the present disclosure.

Terms used in the present disclosure are only used to describe specific embodiments, and are not intended to limit the present disclosure. Singular expressions include plural expressions unless the context clearly dictates otherwise. In the present disclosure, terms such as “comprise” or “have” are intended to designate that there are features, numbers, steps, operations, components, parts, or combinations thereof described in the specification, and it should be understood that this does not preclude the possibility of the presence or addition of one or more other features, numbers, steps, operations, components, parts, or combinations thereof. That is, the description of “including” a specific configuration in the present disclosure does not exclude configurations other than the corresponding configuration, and means that additional configurations may be included in the practice of the present disclosure or the scope of the technical spirit of the present disclosure.

Some of the components of the present disclosure may be optional components for improving performance rather than essential components that perform essential functions in the present disclosure. The present disclosure may be implemented including only components essential to implement the essence of the present disclosure, excluding components used for performance improvement, and a structure including only essential components excluding optional components used only for performance improvement is also included in the scope of the present disclosure.

Hereinafter, embodiments of the present disclosure will be described in detail with reference to the drawings. In describing the embodiments of this specification, if it is determined that a detailed description of a related known configuration or function may obscure the gist of the present specification, the detailed description will be omitted. The same reference numerals are used for the same components in the drawings, and redundant descriptions of the same components are omitted.

The following describes the method and system for collecting data for training and performance monitoring of artificial intelligence models for location measurement.

That is, the present disclosure relates to a method for NWDAF to collect input data for training an AI (or/and ML) model for position measurement or for monitoring the performance of an AI model.

In a basic wireless communication system, LMF can check through Unified Data Management (UDM) whether the terminal (or user equipment (UE)) has provided user consent for data collection for specific purposes.

For example, if user consent is provided, LMF may request data from the UE. For another example, if user consent is not provided, the UE may not be included in data collection. That is, the UE may not perform data collection without user consent.

On a basic wireless communication system, NWDAF may perform AI model training or AI model performance monitoring for (AI/ML) location measurement in LMF.

NWDAF may subscribe to input data from LMF for training the AI model described above or/and monitoring the performance of the AI model. For example, when NWDAF requests input data from LMF, it may use the Area of Interest (AoI), the address to which the notification is sent, the number of requested data samples, and the time window for data collection.

As described above, when the NWDAF on a basic wireless communication system requests input data from the LMF, it does not specify the purpose of the collected data.

Meanwhile, since LMF checks whether the user consents to data collection for the UE for specific purposes, LMF needs to know the purpose of the NWDAF's data collection in order to collect UE data.

Accordingly, when the NWDAF subscribes to input data related to LMF, by specifying the purpose of data collection, a method may be disclosed in which LMF confirms user consent for data collection of UEs for specific purposes.

As an example of the present disclosure, NWDAF may subscribe to input data of LMF by specifying the purpose of data collection for data collection from LMF.

LMF may obtain user consent information for data collection of UEs for specific purposes from UDM, and compare the obtained user consent information with the data collection purpose provided by NWDAF.

And, if the user has agreed to the purpose of data collection provided by NWDAF, LMF may provide data about the UE to NWDAF.

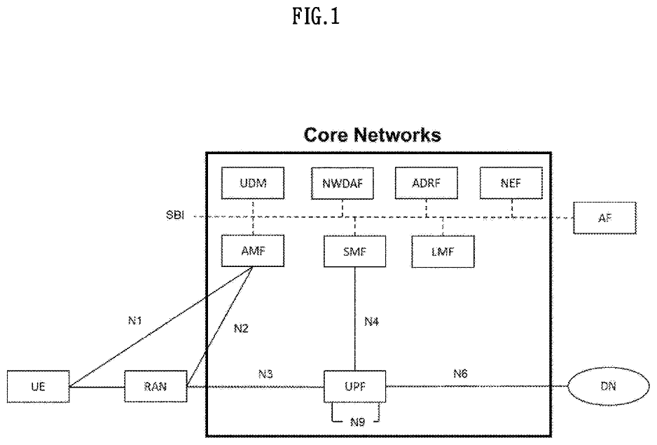

FIG. 1 is a diagram illustrating the configuration of a 5G mobile communication network.

As an example of the present disclosure, as illustrated in FIG. 1, within a 5G mobile communication network (e.g., core network), the Access and Mobility Management Function (AMF), Session Management Function (SMF), LMF, UDM, NWDAF, Analytics Data Repository Function (ADRF), Network Exposure Function (NEF), etc., can communicate through a Service Based Interface (SBI) as functional elements of the control plane.

In describing the present disclosure, each of AMF, SMF, LMF, UDM, NWDAF, ADRF, and NEF may be expressed as an AMF device, SMF device, LMF device, UDM device, NWDAF device, ADRF device, and NEF device, etc.

AMF and UE can be interfaced/connected through N1, AMF and RAN can be interfaced/connected through N2, RAN and UPF (User Plane Function) can be interfaced/connected through N3, UPF can be interfaced/connected through N9, and UPF and Data Network (DN) can be interfaced/connected through N6.

In addition, SMF and UPF can be interfaced/connected through N4 or SBI, and RAN and AMF can also be interfaced/connected through SBI.

LMF is a network function (NF) responsible for location services (LCS) and can perform the role of calculating and providing the location of UEs. For example, LMF can collect and analyze accurate location data by interacting with various network functions such as RAN, AMF, UDM, and NWDAF.

LMF can support UE location measurement and AI/ML-based UE location measurement. The UE location measurement method of LMF may be changed by LMF internal logic or by requests from other NFs (e.g., NWDAF, etc.) and may vary depending on network operator policies.

To perform AI/ML-based UE location measurement in LMF, training of an AI model (i.e., an AI/ML model) is required, and monitoring of the performance of the AI model may be necessary.

That is, training of the AI model required for AI/ML-based UE location measurement in LMF is necessary, and the function of monitoring the performance of the AI model can be performed in LMF or NWDAF.

LMF should collect input data for AI/ML-based UE location measurement, training of AI models, and monitoring of AI model performance, and may request PRU/UE to provide location information or RAN (radio access network) to provide location-related measurement data if necessary.

To collect UE data from a UE or a RAN, the LMF may check user consent and/or a Location Services (LCS) privacy profile in interworking with the UDM.

The Gateway Mobile Location Centre (GMLC) may check the LCS privacy profile in conjunction with the UDM to process UE location requests from other entities. That is, the GMLC may perform the above-described operations on the same and/or different systems together with LMF, etc.

UDM can manage and provide user consent information for specific purposes. LMF may check user consent for specific purposes through UDM and collect UE data only for purposes for which user consent has been granted.

An LMF may request UE data from a UE or RAN by specifying the purpose of the data collection. A UE or RAN that receives a request for data collection from an LMF may decide whether to provide UE data based on the provided purpose of the data collection.

UDM may manage user information in an integrated manner and support network authentication and configuration. UDM may provide Subscriber Data Management (SDM) services that manage user subscription information.

Consumer NFs including AMF, SMF, SMSF, NEF, NWDAF, LMF, etc. may request and subscribe to user subscription information from UDM.

The subscription data types of user subscription information provided by UDM can be classified into several types, and user consent can be one of the subscription data types.

UDM may manage whether to consent to UE data collection by distinguishing based on the provided services.

For example, the services provided may be classified into AI/ML services, XR services, Location services, Sensing services, IoT services, NTN (non-terrestrial network) services, energy-related services, etc.

UDM may manage and provide UE data collection consent for each data collection purpose.

For example, UDM may manage whether to consent to UE data collection based on a combination of the services provided and the purpose of data collection, and may distinguish consent to data collection based on specific purpose, specific data context, or/and data type even within the same service.

That is, UDM may manage and provide consent for UE data collection by data context or/and data type.

As an example of the present disclosure, the purpose of data collection for AI/ML related services may be classified into calculation (or determination), analytics (or inference), AI/ML model training, AI/ML model performance monitoring, etc., as shown in Table 1.

For example, among the purposes of data collection, AI/ML model training may include monitoring AI/ML model performance.

For example, when training an ML model for AIML positioning or monitoring performance in LMF, LMF may check whether the user consents to the “model training” purpose through UDM.

For example, when NWDAF trains an ML model for AIML positioning or monitors performance, NWDAF requests data related to the UE from LMF, and LMF can confirm user consent for the purpose of “model training” through UDM. If user consent for the purpose of “model training” is confirmed, LMF may provide the UE data to NWDAF.

That is, UDM may manage and provide UE data collection consent for each of the computations, analyses, AI/ML model training and/or AI/ML model performance monitoring described above.

TABLE 1

| Subscription | | |
|---|---|---|
| data type | Field | Description |
| User | User | Indicates whether the user has given |
| consent | consent | consent for collecting, distributing |
| | for UE | and analyzing UE related data. User |
| | data | consent is provided per purpose (e.g. |
| | collection | calculation, analytics, model training, |
| | | model performance monitoring). |

UDM may manage and provide privacy configurations (or settings) for target UEs.

Additionally, the UDM may manage and provide the privacy configurations of the target UE. For example, the LMF may collect the UE's location information to train or/and monitor the performance of the AIML model used for UE location measurement. In this case, the LMF can check the UE's LCS privacy profile through the UDM.

LMF may be used to perform UE positioning on a trained AIML model.

For example, before another entity requests the determination of the UE's location, the GMLC may check the LCS privacy profile to ensure that the entity has permission to access the UE's location information. In this case, the LMF may not need to perform additional authentication procedures to calculate the UE's location.

In describing the present disclosure, other entities may refer to, but are not limited to, LCS clients, NWDAF devices, AF, AMF, etc. Other entities may be various types of functional modules and/or devices.

As an example of the present disclosure, an LMF may call the Nudm_SDM_Get or Nudm_SDM_Subscibe service operation to check the LCS privacy profile of a UE.

For example, as shown in Table 2, the subscription data type can be designated as “LCS privacy”.

TABLE 2

| Subscription | | |
|---|---|---|
| data type | Field | Description |
| LCS Privacy | LCS privacy | Provides information for LCS privacy |
| | profile data | classes and Location Privacy Indication |
| | | (LPI). |

As an example of the present disclosure, LMF may perform UE positioning using a trained AIML model.

GMLC may check the UE's LCS privacy profile through UDM to process UE positioning requests from other entities.

Before forwarding a UE positioning request from another entity to the LMF, GMLC can verify whether the LCS client has permission to access UE location information by checking the LCS privacy profile.

That is, as an embodiment of the present disclosure, GMLC may call the Nudm_SDM_Get or Nudm_SDM_Subscibe service operation to check the UE's LCS privacy profile.

As an embodiment of the present disclosure, GMLC may specify the Subscription data type as “LCS privacy” to call the Nudm_SDM_Get or Nudm_SDM_Subscibe service operation.

In one embodiment of the present disclosure, GMLC may simultaneously check the UE's LCS privacy profile and user consent through a single call to Nudm_SDM_Get or Nudm_SDM_Subscibe service operation.

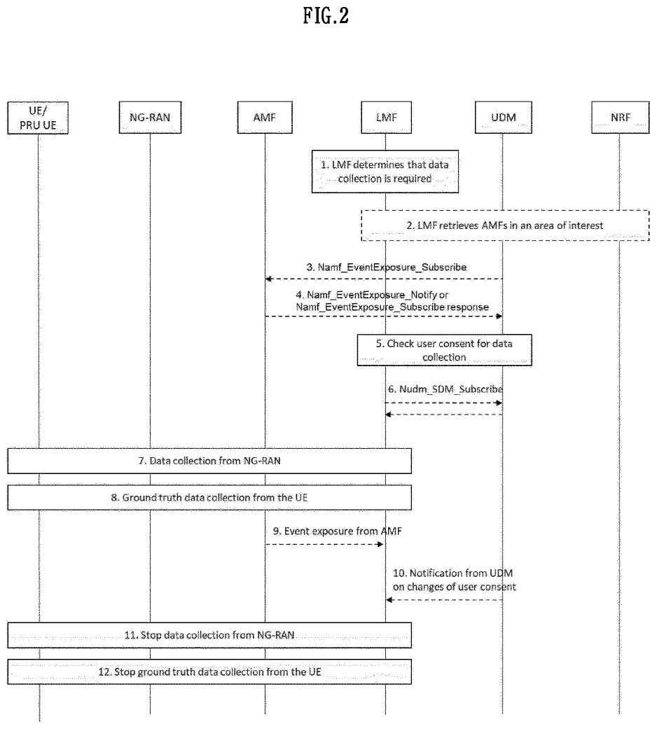

FIG. 2 is a drawing illustrating a data collection method for learning an LMF-based position measurement model or monitoring performance according to one embodiment of the present disclosure.

As described above, the location measurement AI model (or, AI/ML model) and the training or/and performance monitoring of said AI model can be performed in LMF.

As an example of the present disclosure, the procedure illustrated in FIG. 2 may include an operation to measure the location of a UE using an AI model for LMF-based location measurement and an operation to collect input data performed by the LMF to learn the AI model or monitor its performance.

### Step 1

The LMF may determine whether data collection is required to monitor i) UE location measurement operations based on the AI model, ii) training operations of the AI model and/or iii) performance of the AI model.

Additionally or alternatively, the LMF may start data collection at the request of other NF(s) including NWDAF.

### Step 2-a

As an example of the present disclosure, if the LMF already knows the SUPI (Subscription Permanent Identifier) of the UE(s) from which data is to be collected, the procedure described below may be performed.
Step 2-a-1: This applies to the case where an AI/ML model is being trained using a PRU (Positioning Reference Unit).
Step 2-a-2: When The LMF wants to find other PRU-serving LMF(s) associated with a PRU within an Area of Interest (AoI), it may search for other PRU-serving LMF(s) by sending an “Nnrf_NFDiscovery request” to the NRF.
Step 2-a-3: The LMF may receive location information of the PRU and measurement data of the RAN by sending an “Nlmf_Location_MeasurementData request” for the discovered PRU-serving LMF (s).

### Step 2-b

As an example of the present disclosure, if the LMF does not know the SUPI of the UE(s), the procedure described below may be performed.
Step 2-b-1: The LMF may find the AMFF(s) responsible for the region by sending “Nnrf_NFDiscoveryRequest” to the NRF.
Step 2-b-2: The LMF may obtain a list of SUPIs from the AMFF(s) retrieved through Step 3.

### Step 3

The LMF may request AMF to subscribe to the list of SUPIs within the region of interest.

For example, the LMF may call the “Namf_EventExposure_Subscribe” service to request a subscription. Additionally, or alternatively, the LMF may specify the Target of Event Reporting as “Any UE”.

In this case, the event ID can be designated as “UEs in/out area of interest”.

### Step 4

The AMF may provide a list of SUPIs within the region of interest to LMF at the request of LMF.

As an example of the present disclosure, the AMF may provide a list of SUPIs within a region of interest as the LMF through “Namf_EventExposure_Subscribe Response” or “Namf_EventExposure_Notify”.

The LMF may perform subsequent steps based on each SUPI provided by AMF.

### Step 5

LMF can verify user consent for data collection for specific purposes by linking with UDM.

As an example of the present disclosure, LMF can determine whether user consent is given for a specific purpose.

Here, specific purposes may include computation (or determination), AI/ML model inference, AI/ML model training, AI/ML model performance monitoring, etc.

For example, among the purposes of data collection, AI/ML model training may include monitoring AI/ML model performance.

For example, when training an ML model for AIML positioning or monitoring performance in LMF, LMF may check user consent for the purpose of “model training” through UDM.

Meanwhile, LMF may also check the UE's LCS privacy profile information.

The LMF may check the UE's user consent and LCS privacy profile for the Nudm_SDM_Get or Nudm_SDM_Subscribe service operation provided by UDM.

The LMF may simultaneously check the UE's LCS privacy profile and user consent through a single Nudm_SDM_Get or/and Nudm_SDM_Subscibe service operation call.

LMF may first check the UE's user consent and then check the LCS privacy profile by calling the Nudm_SDM_Get or Nudm_SDM_Subscibe service operation.

Here, location data of UEs for which LCS privacy is not permitted may not be collected.

As another example, if a user does not consent to any collection purpose, LMF may not collect data from the UE, and the UE's data may not be used for AI/ML model training or performance monitoring.

### Step 6

The LMF may make a subscription request to UDM to receive notifications of user consent or/and changes to LCS privacy for the corresponding SUPI.

In response to a subscription request from LMF, the “Nudm_SDM_Subscribe” service operation provided by UDM can be used.

Actions according to Step 7 and/or Step 8 may be performed only when user consent is granted for a specific purpose.

Additionally or alternatively, the action according to step 7 and/or step 8 may be performed only if LCS privacy is permitted.

### Step 7

The LMF may request location-related measurement data of the target UE from NG-PAN and receive location-related measurement data of the target UE in response to the request. At this time, LMF may specify the purpose of data collection to NG-PAN.

For example, a NG-PAN may check user consent for the purpose of collecting UE data provided.

Data collection purposes may include computation (or/and judgment), AI/ML model inference, AI/ML model training, and AI/ML model performance monitoring.

For example, if the user does not agree to the data collection purpose specified by the LMF, the NG-RAN may not provide the UE's location measurement data to the LMF.

For example, the NG-RAN may provide the UE's location measurement data to LMF only when the user has agreed to the data collection purpose specified by LMF.

For example, the user consent verification process performed in NG-RAN can be performed based on user consent information managed internally by NG-RAN.

Also, the user consent verification process performed in NG-RAN may be performed in conjunction with UDM.

### Step 8

The LMF may request location information (e.g., Ground Truth data) from the UE and receive location information from the UE. In this case, the LMF may specify the purpose of data collection to the UE.

Data collection purposes may include computation (or/and judgment), AI/ML model inference, AI/ML model training, and AI/ML model performance monitoring.

The UE may determine whether to provide UE data for the purpose of collecting the provided data.

For example, if the user does not agree to the data collection purpose specified by the LMF, the UE may not provide Ground Truth data to the LMF.

For example, the UE may provide Ground Truth data to the LMF only when the user has agreed to the data collection purpose specified by the LMF.

The user consent check process performed in the UE may be performed based on policy rules managed internally by the UE.

The user consent check process performed in the UE may be performed based on configuration information received from the core network.

### Step 9

The LMF may determine that a specific terminal (UE) is no longer located in a configured area of interest (AoI) based on a service notification received from AMF (e.g., using the Namf_EventExposure service).

Here, LMF may perform subsequent steps (e.g., actions according to steps 11 and 12) to terminate location data collection for the UE and may cancel the subscription to the “User consent change notification” requested from the UDM.

### Step 10

The UDM may notify the LMF of a change in user consent or/and LCS privacy status. If data has already been collected for a UE for which user consent is no longer granted or LCS privacy is not allowed, the LMF may perform the actions according to steps 11 and 12.

When the UE's user consent or/and LCS privacy status is changed (or withdrawn), the UDM may notify the LMF that the UE's user consent status has changed via “Nudm_SDM_Notification”.

For example, the notification may include a user identifier (SUPI) and a data type (Subscription Data Type) set to “User consent”.

For example, an LCS privacy status change notification may include a Subscription Data Type set to SUPI and “LCS privacy”.

The LMF may immediately initiate a procedure to stop collection (e.g., the action according to steps 11 and 12) even if data collection is already in progress for a UE whose consent has been withdrawn.

Additionally, LMF can unsubscribe from the user consent change notification for the corresponding SUPI via “Nudm_SDM_Unsubscribe”, and can also specify the SUPI and “User consent” type when making such a request.

Additionally or alternatively, for each SUPI whose LCS privacy has been withdrawn, the LMF may unsubscribe from the LCS privacy change notification subscription to UDM via Nudm_SDM_Unsubscribe, and the request may include the SUPI and a Subscription Data Type set to “LCS privacy”.

### Step 11

The LMF may request NG-RAN to stop reporting location-related measurement data of the corresponding UE.

### Step 12

The LMF may stop collecting location information (e.g., Ground Truth data) from the UE.

Location-related measurement data and location information (e.g., ground truth data) collected from LMF may be used to train AI/ML models.

In addition, the location of the UE is estimated from the measurement data through an LMF-based AI/ML location measurement model, and the estimated UE location and ground truth data can be used to monitor model performance.

The LMF may start collecting data for multiple UEs simultaneously, in which case the operations according to steps 7 and 8 can be performed in parallel.

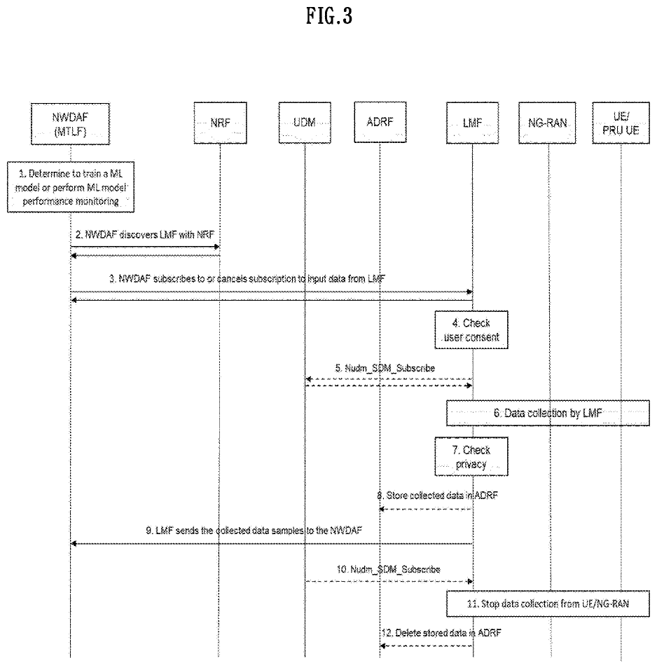

FIG. 3 is a drawing illustrating a method for collecting input data of an NWDAF for training and/or performance monitoring of an AI model for position measurement according to one embodiment of the present disclosure.

Here, The NWDAF may perform AI model training or/and performance monitoring for LMF-based location measurement. The NWDAF may subscribe to input data from LMF for this purpose.

Input data that NWDAF subscribes to from LMF may include terminal location information (e.g., ground truth data) and location-related measurement data.

### Step 1

In one embodiment of the present disclosure, the NWDAF may decide to perform AI model training for LMF-based location measurement or/and AI model performance monitoring based on a request from LMF or/and internal logic of said NWDAF.

### Step 2

The NWDAF may discover the above LMF through the NRF (Network Repository Function).

Specifically, the NWDAF may call the ‘Nnrf_NFDiscovery_Request’ service operation to search for the LMF.

Here, the search request may include an Area of Interest (AoI) and the ‘Nlmf_DataExposure’ service as search parameters.

As an example of the present disclosure, when NWDAF intends to collect PRU (Positioning Reference Unit) input data, the search parameter may further include a PRU existence indication.

The above NRF can select at least one LMF based on information received from the above NWDAF and send a ‘Nnrf_NFDiscovery_Request_Response’ message including profile information of the selected LMF to the above NWDAF.

### Step 3

NWDAF can subscribe to or unsubscribe from the input data of the LMF by calling the service operation ‘Nlmf_DataExposure_Subscribe’ or ‘Nlmf_DataExposure_UnSubscribe’.

When the above NWDAF requests input data, the request message may include at least one of the following information:
AoI;
Notification Target Address;
Notification Correlation ID;
Requested number of data samples;
Time Window of data samples;
Purpose for data collection;
User consent check information (e.g., an indication that the data consumer has checked user consent)
Data source type (e.g., terminal (UE) or base station (NG-RAN));
Quality threshold; and
AI/ML model identifier (i.e., identifier for AI/ML model performance monitoring).

Here, the ‘purpose of data collection’ may include at least one of AI/ML model inference, AI/ML model training, and AI/ML model performance monitoring.

The above ‘quality threshold’ may mean a parameter that instructs the LMF to provide the data only when the collected ground truth data satisfies the threshold.

If the collected data sample does not contain the quality indicator of the ground truth data, the LMF may be configured not to transmit the data sample to the NWDAF.

### Step 4

LMF may be linked with UDM to check whether there is ‘User consent’ for the purpose of collecting data from the above UE.

The LMF may proceed with data collection only if the user has consented to the specific purpose of data collection.

GMLC or/and LMF may check and ensure whether an LCS client (e.g., NWDAF) has permission to access UE location information by checking the LCS privacy profile.

The specific purpose managed by the above UDM may include location determination/calculation, AI/ML model inference, AI/ML model training, and AI/ML model performance monitoring.

For example, among the purposes of data collection, AI/ML model training may include AI/ML model performance monitoring.

For example, when training an ML model for AIML positioning or monitoring performance in NWDAF, the LMF may check whether the user consents to the “model training” purpose through UDM. If user consent is confirmed, the LMF may provide data related to the UE to NWDAF.

For example, the LMF may not be able to collect location data from UEs where LCS privacy is not permitted, but is not limited to this.

As another example, if the user does not consent to any collection purpose, the LMF does not collect data from the UE, and the data from the UE may not be used for AI/ML model training or performance monitoring.

If user consent check information is provided from NWDAF in Step 3, the user consent verification procedure of LMF may be omitted.

### Step 5

The LMF may make a subscription request to the UDM to receive notifications of user consent or/and changes to the LCS privacy status for the UE. To this end, the ‘Nudm_SDM_Subscribe’ service operation provided by the UDM may be used.

### Step 6

The LMF may perform a data collection procedure from at least one of the above terminal (UE), PRU, or NG-RAN.

As an example, when performing AI model performance monitoring, the LMF may estimate the location of the UE or the PRU using the collected data and the ML model identified by the ML model identifier received in step 3.

### Step 7

As an example of the present disclosure, when the LMF intends to store collected input data in an Analytics Data Repository Function (ADRF), the LMF may determine whether the ADRF is authorized to store input data used for AI/ML model training or model performance monitoring for terminal (UE) location measurement.

Additionally or alternatively, the GMLC or/and the LMF may check and ensure whether an LCS client (e.g., NWDAF, ADRF, etc.) has the authorization to access UE location information by checking the LCS privacy profile.

The determination of whether to grant the authorization can be made based on the privacy profile (UE privacy profile) of the UE.

### Step 8

If the ADRF is permitted to store the input data as a result of the determination according to Step 7, the LMF may store the collected input data in the ADRF.

Specifically, the LMF may store the collected input data in the ADRF using the ‘Nadrf_DataManagement_StorageRequest’ service operation.

As an example of the present disclosure, when the LMF calls the service operation, it may provide at least one of the following information to the ADRF:
Notification Endpoint information (e.g., NWDAF MTLF): When the ADRF deletes previously stored data, it may be used as a destination to send a notification to the NWDAF.
Data collection service operation indicator: This may specify a service operation used by the LMF to collect UE location information from the terminal and to collect UE location-related measurement data from the base station (NG-RAN). The specified service operation may include a Service Based Interface (SBI) related to data collection.

### Step 9

The LMF may transmit the collected data samples to the NWDAF. Accordingly, the NWDAF may train an ML model based on the received data samples or monitor the performance of the ML model.

In one embodiment of the present disclosure, LMF may call the ‘Nlmf_DataExposure_Notify’ service to deliver collected data samples.

Here, the information provided by the LMF to the NWDAF may include at least one of a location-related measurement data sample collected from a base station, ground truth data (e.g., location of a PRU or UE) and its quality indicator, an ML model identifier, an ADRF identifier (ADRF ID) and a DataSetTag, a data usage reporting indicator, and/or an error response.

### Step 10

When a change in the privacy profile or a change in user consent related to the Location Service (LCS) of the UE occurs, the UDM may send a notification message to the subscribed consumer (e.g., the LMF) to notify the information.

If the LMF that received the notification from the UDM confirms that the user consent of the UE is no longer granted, it may perform the operation according to step 11 described below.

Additionally or alternatively, if the LMF is found to have been updated so that the UE's LCS privacy profile no longer receives the UE location information, it may perform the operation according to step 12 described below.

### Step 11

Upon withdrawal of user consent, etc., LMF may immediately stop collecting direct location information (e.g., ground truth data) from the UE and collecting measurement data related to the UE's location from the base station (NG-RAN).

### Step 12

If data retention is not possible due to privacy profile updates, etc., the LMF may send a data deletion request to the above ADRF.

The data deletion request can be performed through the ‘Nadrf_DataManagement_Delete’ service operation, and when the request is made, the LMF may include a DataSetTag attribute associated with the stored data record to be deleted.

Upon receiving the data deletion request from the LMF, the ADRF may delete the specified data and send a notification to the NWDAF indicating that the data has been successfully deleted.

As an example of the present disclosure, after the LMF provides a data sample to NWDAF, the LMF or UDM may be configured to verify and confirm whether NWDAF actually used the data in accordance with the data collection purpose specified in advance.

To this end, NWDAF should be configured to support the capability to report data usage status and results, and the procedure for reporting data usage results can be performed through at least one of the following embodiments.

### Embodiment 1

Embodiment 1 relates to a procedure based on reporting indication when providing data.

If the LMF provides the above data sample to the NWDAF, including a ‘data usage reporting indication’, the NWDAF may have an obligation to report to the LMF the results of whether the data was used in accordance with the collection purpose.

### Embodiment 2

Embodiment 2 relates to a service subscription-based procedure.

As an example of the present disclosure, the LMF or the UDM may explicitly subscribe to a service related to ‘data usage status and results reporting’ provided by the NWDAF.

The LMF or the UDM may receive reports from the NWDAF on the status of data usage and results on a continuous or event basis based on the subscription procedure.

In the above-described Embodiment 1 and/or Embodiment 2, the reporting time of the data usage result performed by the NWDAF and the contents included in the report may be set as follows:

Report time: The results of the data usage may be reported at pre-set periods, or triggered and reported after the operation according to the above collection purpose (e.g., ML model inference, ML model training, or ML model performance monitoring) is completed.

Report content: The results of the data usage may go beyond simple usage and may directly include the results of the ML model inference, the results of the ML model training, or the results of the ML model performance monitoring.

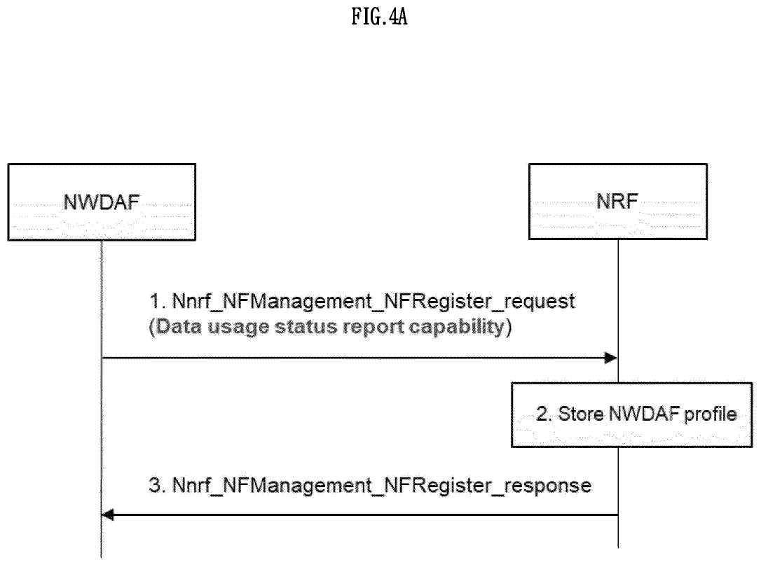

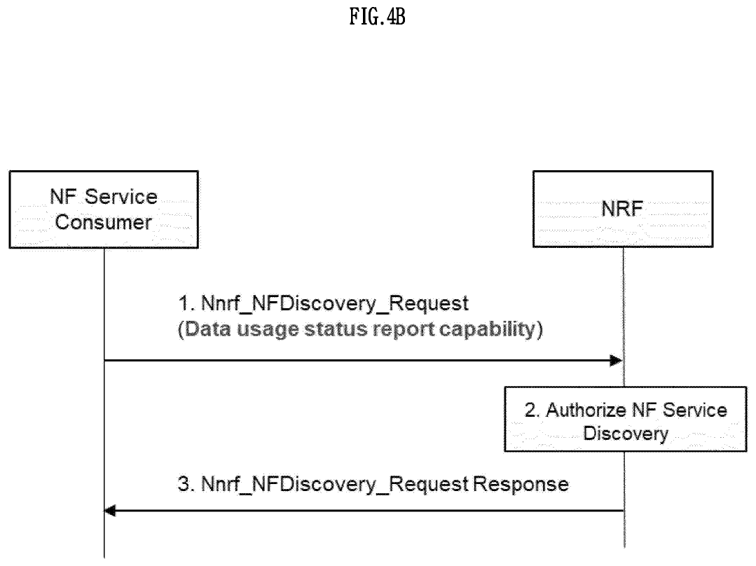

FIGS. 4A and 4B are drawings for illustrating the NRF registration and NWDAF discovery procedures of an NWDAF profile that supports the capability to report data usage status and results, according to one embodiment of the present disclosure.

That is, FIG. 4A relates to an NWDAF service profile registration procedure according to one embodiment of the present disclosure, and FIG. 4B relates to an NWDAF discovery procedure according to one embodiment of the present disclosure.

As an example of the present disclosure, referring to FIG. 4A, a procedure for registering an NWDAF profile between an NWDAF and a Network Repository Function (NRF) can be performed.

In Step 1, assume that the NWDAF supports a data usage status report capability. In this case, the NWDAF may request registration of an NWDAF profile configured to include basic information elements (e.g., information included in a conventional NWDAF profile) and a ‘data usage status report capability’ parameter to the NRF.

In step 2, the NRF may store and manage the received NWDAF profile information.

As an example of the present disclosure, an NWDAF discovery operation can be performed as shown in FIG. 4b.

For example, after the registration procedure of FIG. 4A, a procedure may be performed for a consumer network function (Consumer NF) to discover an NWDAF that provides a specific service.

In Step 1, when another Consumer NF wants to discover an NWDAF that provides a data usage status reporting service, the Consumer NF may send a discovery request to the NRF including the ‘data usage status reporting capability’ indicator in the conventional discovery request information.

In step 2, the NRF may search through a number of previously registered NWDAF profiles to identify at least one target NWDAF that supports the data usage status reporting capability.

In step 3, the NRF may transmit the profile information of the identified target NWDAF to the Consumer NF via a response message.

The following is a diagram to explain the method of extending the service related to data provision of the LMF.

As an example of the present disclosure, the LMF may extend data provisioning related services to enable an NF Service Consumer (e.g., NWDAF) to subscribe to input data for training an ML model for AI/ML-based location measurement, ML model inference, or ML model performance monitoring.

In addition, the NF service consumers may subscribe to data required for providing next-generation services, including XR, Location, Sensing, IoT, Energy, and Non-Terrestrial Network (NTN), in addition to AI/ML services.

To this end, the NF service consumer may call the ‘Nlmf_DataExposure_Subscribe’ service operation, and the subscription request message may include the following first information group as required, or additionally include the following second information group.

### First Information Group (Basic Parameters)

Notification Target Address;
Notification Correlation ID; and/or
Area of Interest (AoI).

### Second Information Group (Additional Parameters)

Time Window;
Requested number of data samples;
Subscription Correlation ID;
Expiry time;
Purpose for data collection;
User consent check information (e.g., an indication that the data consumer has checked user consent);
Data source type (e.g., UE or NG-RAN);
Quality threshold; and/or
ML model identifier.

The following describes the method for providing data notifications and handling error responses.

When the subscription request of the NF service consumer is accepted, the LMF may provide the NF service consumer with a notification regarding input data that is suitable for the purpose of data collection.

The above notification is delivered via the ‘Nlmf_DataExposure_Notify’ service operation and may include at least one of the following information:
Notification Correlation ID;
Location-related measurement data samples collected from base stations (NG-RAN);
Ground Truth data (e.g., PRU or UE location) and quality metrics of the ground truth data;
ML model identifier and PRU/UE location estimate (e.g., applied when monitoring ML model performance); and/or
Newly assigned Subscription Correlation ID and ADRF Identifier/DataSet Tag.

As an example of the present disclosure, if the LMF is unable to normally provide the requested input data to the NF service consumer, the LMF may provide an error response including a cause code indicating the cause of the failure.

The cause code of the above error response may indicate at least one of the following cases:
The collected data does not meet the requested number of data samples;
User consent is not granted for the requested specific data collection purpose;
The quality of the collected data falls below the requested quality threshold; and/or
The requested data source type is undefined.
Error on User consent (e.g., user consent is not granted)
Error on LCS privacy profile check (e.g., UE is not allowed to be located or UE LCS privacy profile has been revoked).

Additionally or alternatively, if the LMF device directly calculates (or estimates) the location of the UE using an AI model, the LMF device may skip a separate user consent verification process and perform only the process of checking the LCS privacy profile.

Specifically, before processing an actual location determination request, the LMF device may check the LCS privacy profile of the UE to verify whether the target LCS client (e.g., NWDAF device or/and AF device, etc.) has authorization to access the location information of the UE.

When training an AI model for location measurement or monitoring the performance of an AI model, at least one of the following user consent verification methods may be applied depending on the entity performing the task.

The first Method (LMF Subject): When the LMF device independently trains an AI model or monitors performance, the LMF device directly verifies whether the above UE has user consented to the “model training” purpose through the UDM device.

The second Method (NWDAF Subject—LMF Proxy Verification): When an NWDAF device requests input data from an LMF device to train an AI model or monitor performance, the LMF device receiving the request may check whether the user consents to the purpose of “model training” through a UDM device. Only if the consent is confirmed, the LMF device may provide data related to the UE to the NWDAF device.

The third Method (NWDAF Subject—NWDAF Direct Verification): The NWDAF device may be configured to directly verify in advance whether the user of the UE has consented to the purpose of “model training” through the UDM device. In this case, when the NWDAF device requests input data from the LMF device, it may include information indicating that user consent has already been verified (e.g., user consent check information or indications) in the request message and transmit it. Upon receiving the indications, the LMF device may omit duplicate user consent verification.

Additionally or alternatively, when the collected UE-related data is to be stored in the ADRF device during the process of training an AI model for location measurement or/and performance monitoring in the LMF device or NWDAF device, an additional privacy check (LCS privacy check) may be performed.

For example, before the LMF device stores collected input data in the ADRF device, it may determine whether the ADRF device is authorized to store UE-related data based on the terminal's privacy profile.

If the determination result indicates that the ADRF device is authorized to store the input data, the LMF device may request the ADRF device to store the collected input data using the ‘Nadrf_DataManagement_StorageRequest’ service operation.

For example, when the LMF device calls the service operation, it may provide the information described below to the ADRF device:
i) Notification endpoint information: The LMF device may provide address information of the NWDAF device so that the ADRF device may transmit a notification to the NWDAF device when the data is subsequently deleted.
ii) Data collection service operation information: The LMF device may provide information by specifying the service operation used to collect UE location information from the UE and the service operation used to collect UE location-related measurement data from the base station (NG-RAN), respectively.

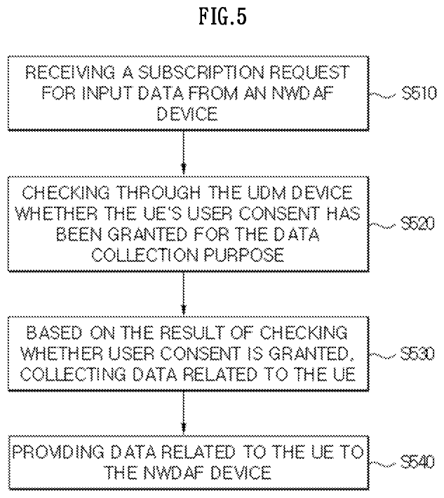

FIG. 5 is a flowchart illustrating a method for collecting input data and estimating performance of an AI model for position estimation according to one embodiment of the present disclosure.

As an example of the present disclosure, an LMF device may receive a subscription request for input data from an NWDAF device (S510).

Here, the subscription request may include a clear ‘data collection purpose’ for which the NWDAF device intends to collect data, but is not limited thereto.

For example, the purpose of data collection may include at least one of the purpose of inferring an AI (Artificial Intelligence)/ML (Machine Learning) model, the purpose of training the AI/ML model, and the purpose of monitoring the performance of the AI/ML model. Additionally, the purpose of training the AI/ML model may include the purpose of monitoring the performance of the AI/ML model.

After receiving a subscription request, the LMF device may check through the UDM device whether the UE's user consent has been granted for the data collection purpose specified above (S520).

As an example of the present disclosure, based on the result of checking whether user consent is granted, the LMF device may collect data related to the UE (S530).

For example, the process of an LMF collecting data related to a UE includes a procedure for acquiring data from a base station (e.g., NG-RAN) device and a UE.

Specifically, the LMF device may request location-related measurement data of the UE from the base station device by specifying the purpose of data collection, and the base station device may provide the location-related measurement data to the LMF device only if consent is given, after confirming user consent based on the provided purpose of data collection.

In addition, the LMF device may directly request location information, which is Ground Truth data, by specifying the purpose of the data collection to the UE. The UE may complete the input data collection process by the LMF device by providing the location information to the LMF device only when user consent regarding the provided purpose of data collection is confirmed.

And, the LMF device may provide data related to the collected UE to the NWDAF device (S540).

As another example of the present disclosure, if it is determined that the user consent for the purpose of data collection has not been granted, the LMF device may transmit an error response to the NWDAF device containing a cause code indicating that data related to the terminal cannot be provided to the NWDAF device.

This allows for the selective collection of only the data that meets the purpose while protecting user privacy.

In addition, the LMF device may perform data storage and privacy profile-based authorization verification.

For example, the LMF device may store data related to the collected UE in an Analytics Data Repository Function (ADRF) device.

Here, data related to the UE is not unconditionally stored in the ADRF device, but rather, it can be determined in advance whether the ADRF device is authorized to store the input data based on the UE's privacy profile.

Additionally, when the LMF device provides the collected data to the NWDAF device, it may also transmit a data usage reporting indication.

The NWDAF device that received the data usage report instruction may generate a result regarding whether the data related to the UE was actually used in accordance with the data collection purpose originally specified.

By receiving the data usage results from the NWDAF device, the LMF device may prevent misuse after data collection and check whether the purpose is being met.

Meanwhile, the types and functions of each parameter included in the subscription request (e.g., “Nlmf_DataExposure_Subscribe”) that the NWDAF device sends to the LMF device may be as follows.
Area of Interest (AoI): This restricts the specific geographical or logical area subject to data collection, thereby preventing the collection of data from unnecessary areas.
Notification Target Address and Notification Correlation ID: This can serve as the destination address to which the data collected by the LMF device will be transmitted, and as a correlation ID to identify which subscription request the receiving side will map to that data.
Requested number of data samples and data collection time window: This can control the system load by limiting the total amount of data related to the terminal to be collected (e.g., number of samples) and the specific time range in which the data must be collected.
Data source type: This can clearly specify whether the data source is a terminal (UE) or a wireless access network (NG-RAN).
Quality threshold: This can be a filtering criterion that instructs the Ground Truth data collected by the LMF to be passed to the NWDAF only when it meets a certain level of quality (e.g., accuracy).
Subscription Correlation ID and Expiry Time: This allows you to manage the subscription lifecycle by setting the unique identifier of the created subscription session itself and how long the subscription is valid.
AI model identifier: This allows for the unique identification of the target AI model when requesting data for the purpose of monitoring the performance of a specific AI model.

Additionally or alternatively, the LMF device may perform actual location positioning for the UE using an AI model that has been trained through the data collection and learning process described above.

This AI model-based positioning operation can be triggered by a positioning request from an external entity (e.g., an LCS client or/and an AF (application function)) that wants to access the UE's location information.

Specifically, when a location positioning request for a UE is received by a Gateway Mobile Location Centre (GMLC) device from another entity, the GMLC device may perform privacy authorization check before unconditionally forwarding the request to an LMF device.

That is, the GMLC device may check the UE's Location Service (LCS) privacy profile through the UDM device to check whether another entity has legitimate authority to access the UE's actual location information.

Based on the verification of the privacy profile, it is verified that the LCS client corresponding to another entity has the authority to access the UE's location information, and the GMLC device may transmit the location positioning request to the LMF device.

For example, the LMF device that receives a location positioning request from a GMLC device for which authorization verification has been completed can perform a positioning operation to calculate the location of the terminal by immediately utilizing a trained AI model without separately performing a procedure to confirm user consent for the purpose of data collection (which was required in the data collection step described above).

As described above, access control methods can be dualized so that in the ‘data collection (or/and training) phase’ for AI/ML models, the LMF device takes the lead in verifying purpose-specific user consent, and in the actual ‘location positioning (e.g., inference) phase’, the GMLC device takes the lead in verifying the LCS privacy profile.

Through this, the reliability of protecting the privacy of UE users can be maximized, while preventing processing delays caused by unnecessary duplicate authorization verifications when providing actual location services.

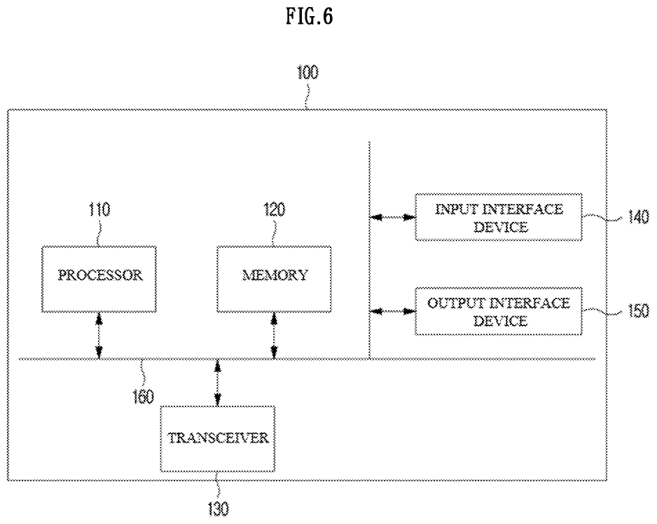

FIG. 6 is a drawing for describing the configuration of a device according to an embodiment of the present disclosure.

The device (100) may include at least one of a processor (110), memory (120), a transceiver (130), an input interface device (140), and an output interface device (150). Each component may be connected by a common bus (160) to communicate with each other. Additionally, each component may be connected via an individual interface or an individual bus centered around the processor (110), rather than by the common bus (160).

The processor (110) can be implemented in various types such as an AP (Application Processor), CPU (Central Processing Unit), GPU (Graphic Processing Unit), etc., and can be any semiconductor device that executes instructions stored in memory (120). The processor (110) can execute program instructions stored in memory (120). The processor (110) can perform various operations described with reference to FIGS. 1 to 5 above.

The processor (110) can control the overall operation and function of the device (100).

And/or, the processor (110) may store program instructions for implementing at least one function for one or more modules in memory (120) to control the operation described based on FIGS. 1 through 5 to be performed.

Memory (120) may include various forms of volatile or non-volatile storage media. For example, memory (120) may include read-only memory (ROM) and random access memory (RAM). In embodiments of the present disclosure, memory (120) may be located inside or outside the processor (110), and memory (120) may be connected to the processor (110) through various known means.

The transceiver (130) may perform the function of transmitting and receiving data processed/to be processed by the processor (110) to an external device and/or an external system.

For example, the transceiver (130) can be used for data exchange with other terminal devices, etc.

The input interface device (140) is configured to provide data to the processor (110).

The output interface device (150) is configured to output data from the processor (110).

Components described in the exemplary embodiments of the present disclosure may be implemented by hardware elements. For example, The hardware element may include at least one of a digital signal processor (DSP), a processor, a controller, an application specific integrated circuit (ASIC), a programmable logic element such as an FPGA, a GPU, other electronic devices, or a combination thereof. At least some of the functions or processes described in the exemplary embodiments of the present disclosure may be implemented as software, and the software may be recorded on a recording medium. Components, functions, and processes described in the exemplary embodiments may be implemented as a combination of hardware and software.

The method according to an embodiment of the present disclosure may be implemented as a program that can be executed by a computer, and the computer program may be recorded in various recording media such as magnetic storage media, optical reading media, and digital storage media.

Various techniques described in this disclosure may be implemented as digital electronic circuits or computer hardware, firmware, software, or combinations thereof. The above techniques may be implemented as a computer program product, that is, a computer program or computer program tangibly embodied in an information medium (e.g., machine-readable storage devices (e.g., computer-readable media) or data processing devices), a computer program implemented as a signal processed by a data processing device or propagated to operate a data processing device (e.g., a programmable processor, computer or multiple computers).

Computer program(s) may be written in any form of programming language, including compiled or interpreted languages. It may be distributed in any form, including stand-alone programs or modules, components, subroutines, or other units suitable for use in a computing environment. A computer program may be executed by a single computer or by a plurality of computers distributed at one or several sites and interconnected by a communication network.

Examples of information medium suitable for embodying computer program instructions and data may include semiconductor memory devices (e.g., magnetic media such as hard disks, floppy disks, and magnetic tapes), optical media such as compact disk read-only memory (CD-ROM), digital video disks (DVD), etc., magneto-optical media such as floptical disks, and ROM (Read Only Memory), RAM (Random Access Memory), flash memory, EPROM (Erasable Programmable ROM), EEPROM (Electrically Erasable Programmable ROM) and other known computer readable media. The processor and memory may be complemented or integrated by special purpose logic circuitry.

A processor may execute an operating system (OS) and one or more software applications running on the OS. The processor device may also access, store, manipulate, process and generate data in response to software execution. For simplicity, the processor device is described in the singular number, but those skilled in the art may understand that the processor device may include a plurality of processing elements and/or various types of processing elements. For example, a processor device may include a plurality of processors or a processor and a controller. Also, different processing structures may be configured, such as parallel processors. In addition, a computer-readable medium means any medium that can be accessed by a computer, and may include both a computer storage medium and a transmission medium.

Although this disclosure includes detailed descriptions of various detailed implementation examples, it should be understood that the details describe features of specific exemplary embodiments, and are not intended to limit the scope of the invention or claims proposed in this disclosure.

Features individually described in exemplary embodiments in this disclosure may be implemented by a single exemplary embodiment. Conversely, various features that are described for a single exemplary embodiment in this disclosure may also be implemented by a combination or appropriate sub-combination of multiple exemplary embodiments. Further, in this disclosure, the features may operate in particular combinations, and may be described as if initially the combination were claimed. In some cases, one or more features may be excluded from a claimed combination, or a claimed combination may be modified in a sub-combination or modification of a sub-combination.

Similarly, although operations are described in a particular order in a drawing, it should not be understood that it is necessary to perform the operations in a particular order or order, or that all operations are required to be performed in order to obtain a desired result. Multitasking and parallel processing can be useful in certain cases. In addition, it should not be understood that various device components must be separated in all exemplary embodiments of the embodiments, and the above-described program components and devices may be packaged into a single software product or multiple software products.

Exemplary embodiments disclosed herein are illustrative only and are not intended to limit the scope of the disclosure. Those skilled in the art will recognize that various modifications may be made to the exemplary embodiments without departing from the spirit and scope of the claims and their equivalents.

Accordingly, it is intended that this disclosure include all other substitutions, modifications and variations falling within the scope of the following claims.

What is claimed is:

1. A method performed by a Location Management Function (LMF) device, the method comprising:
receiving a subscription request for input data from a Network Data Analytics Function (NWDAF) device;
checking whether a user equipment (UE) has user consent for a purpose of data collection through a Unified Data Management (UDM) device; and
collecting data related to the UE based on checking that the user consent for the purpose of data collection has been authorized; and
providing the data related to the UE to the NWDAF device.

2. The method of claim 1, wherein:
the purpose of the data collection includes at least one of an Artificial Intelligence (AI) model inference purpose, an AI model training purpose, and an AI model performance monitoring purpose.

3. The method of claim 1, further comprising:
transmitting, to the NWDAF device, an error response including a cause code indicating that data related to the UE cannot be provided to the NWDAF device, based on checking that the user consent for the purpose of the data collection has not been authorized.

4. The method of claim 2, further comprising:
the subscription request includes at least one of an Area of Interest (AoI), a Notification Target Address, a Notification Correlation ID, a requested number of data samples, a Time Window of data samples, a data source type, a quality threshold, a Subscription Correlation ID, an Expiry time, or an identifier of the AI model.

5. The method of claim 4, further comprising:
the providing data related to the UE to the NWDAF device comprising:
based on a quality indicator of the Ground Truth data included in the data related to the UE being greater than or equal to the quality threshold, transmitting the data related to the UE to the NWDAF device.

6. The method of claim 1, further comprising:
storing the collected data in an Analytics Data Repository Function (ADRF) device.

7. The method of claim 6, wherein the storing the collected data comprising:
determining whether the ADRF device is authorized to store the data based on a privacy profile of the UE.

8. The method of claim 2, further comprising:
performing positioning of the UE through the AI model,
wherein the performing positioning of the UE comprises:
receiving a positioning request from a gateway mobile location center (GMLC) device to perform location positioning of the UE, and
wherein the positioning request is transmitted from the GMLC device to the LMF device when a location positioning request for the UE is made from a different entity to the GMLC device, and the GMLC device verifies that the different entity has authority to access the location information of the UE.

9. The method of claim 2, further comprising:
the AI model training purpose includes a purpose of monitoring a performance of the AI model.

10. A Location Management Function (LMF) device comprising:
at least one memory; and
at least one processor,
wherein the at least one processor is configured to:
receive a subscription request for input data from a Network Data Analytics Function (NWDAF) device;
check whether a user equipment (UE) has user consent for a purpose of data collection through a Unified Data Management (UDM) device; and
collect data related to the UE based on checking that the user consent for the purpose of data collection has been authorized; and
provide the data related to the UE to the NWDAF device.

11. The method of claim 10, wherein:
the purpose of the data collection includes at least one of an Artificial Intelligence (AI) model inference purpose, an AI model training purpose, and an AI model performance monitoring purpose.

12. The method of claim 11, wherein:
the AI model training purpose includes a purpose of monitoring a performance of the AI model.

13. The method of claim 10, wherein:
the at least one processor is configured to:
transmit, to the NWDAF device, an error response including a cause code indicating that data related to the UE cannot be provided to the NWDAF device, based on checking that the user consent for the purpose of the data collection has not been authorized.

14. The method of claim 11, wherein:
the subscription request includes at least one of an Area of Interest (AoI), a Notification Target Address, a Notification Correlation ID, a requested number of data samples, a Time Window of data samples, a data source type, a quality threshold, a Subscription Correlation ID, an Expiry time, or an identifier of the AI model.

15. The method of claim 14, wherein:
the at least one processor is configured to:
based on a quality indicator of the Ground Truth data included in the data related to the UE being greater than or equal to the quality threshold, transmit the data related to the UE to the NWDAF device.

16. The method of claim 10, wherein:
the at least one processor is configured to:
store the collected data in an Analytics Data Repository Function (ADRF) device.

17. The method of claim 16, wherein:
the at least one processor is configured to:
determine whether the ADRF device is authorized to store the data based on a privacy profile of the UE.

18. The method of claim 11, wherein:
the at least one processor is configured to:
perform positioning of the UE through the AI model, and
receive a positioning request from a gateway mobile location center (GMLC) device to perform location positioning of the UE, and
wherein the positioning request is transmitted from the GMLC device to the LMF device when a location positioning request for the UE is made from a different entity to the GMLC device, and the GMLC device verifies that the different entity has authority to access the location information of the UE.

19. A system comprising:
a Location Management Function (LMF) device; and
a Network Data Analytics Function (NWDAF) device,
wherein the LMF device is configured to:
receive a subscription request for input data from the NWDAF device;
check whether a user equipment (UE) has user consent for a purpose of data collection through a Unified Data Management (UDM) device; and
collect data related to the UE based on checking that the user consent for the purpose of data collection has been authorized,
wherein the NWDAF device is configured to:
receive the data related to the UE from the LMF device.
